(19) United States
(12) Patent Application Publication
(10) Pub. No.: US 2008/0047422 A1
(43) Pub. Date: Feb. 28, 2008

(54) Air motor

(76) Inventor: Kenneth Hoopes, Hampstead, NC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/812,873

(22) Filed: Jun. 22, 2007

Related U.S. Application Data
(60) Provisional application No. 60/815,601, filed on Jun. 22, 2006.

(51) Int. Cl. F15B 21/00

(52) U.S. Cl. 91/5; 180/165

(57) ABSTRACT

An oscillating air motor includes one or more cylinders that house a piston. The piston is connected to a crankshaft by a connecting rod. The cylinders are in fluid communication with a solenoid valve that supplies air to the cylinders. The air is forced into the cylinders at a predetermined time causing the piston to move down the cylinders. The cylinder are supported by at least a countershaft that passes through the cylinders. The cylinders are permitted to move about the countershaft. Movement of the cylinders about the countershaft may be used to control input and output valves of the motor. Alternatively, sensors activated by a cam on the camshaft may be used control input and output solenoid valves. Using a two way transfer valve, the engine may be switched to pump mode for regenerative braking.

### FIELD OF THE INVENTION

The present invention relates generally to air motors. More particularly, the present invention relates to an air motor that uses an electronic switching system to control one or more valves of the motor.

### SUMMARY OF THE INVENTION

The invention includes an air motor that includes an electronic switching system to control valves of the air motor. The electronic switching system may control both the input valve for optimizing air expansion during a power stroke of the air motor, and a transfer valve that is used to convert the air motor to a pump for recovering braking energy of a vehicle using the air motor when a braking action is applied. Air captured during braking is pumped into air tanks. Air in these tanks is then fed back into the air motor, now acting as a motor, to accelerate the vehicle back to speed after braking.

According to one embodiment of the invention, an oscillating air motor includes one or more cylinders that house a piston. The piston is connected to a crankshaft by a connecting rod. The cylinders are in fluid communication with a solenoid valve that supplies air to the cylinders. The air is forced into the cylinders at a predetermined time causing the piston to move down the cylinders. The cylinder are supported by at least a countershaft that passes through the cylinders. The cylinders are permitted to move about the countershaft. Movement of the cylinders about the countershaft is used to control input and output valves of the motor. Additionally, the piston runs parallel to the cylinder such that forces transferred from the piston into the cylinder are reduced and the use of low friction material such as, for example, TEFLON® in the piston and cylinder walls allows for oil-less operation of the motor whether implemented as an air motor or as a steam engine.

According to one embodiment of the invention, an oscillating air motor includes one or more cylinders that house a piston. The piston is connected to a crankshaft by a connecting rod. The cylinders are in fluid communication with solenoid valves that supply air to the cylinders and open exhaust valves during an exhaust phase of motor operation. Air is forced into the cylinders when a pulse is sent to the solenoid valves controlling the air admitted to the cylinders. The air causes the piston to move down the cylinders. The cylinders are supported by a countershaft that passes through brackets mounted on the top of the cylinders. The cylinders are permitted to move about the countershaft. This movement allows the pistons to run parallel to the cylinder such that forces transferred from the piston into the cylinder are reduced to a point where low friction piston rings and cylinder liners allow for oil-less operation of the motor whether implemented as an air motor or as a steam engine.

The invention may also include conical piston seals that seal the piston inside the cylinder in such a way that the more the pressure presses down on the cylinder, the more the piston pushes against the cylinder wall, thus sealing the piston/cylinder gap. This type of conical piston seal provides for a more efficient air motor or a closed cycle steam engine.

The invention may also include conical washers that may be used within an exhaust valve of an air motor and the exhaust and input valve of a steam engine. Conical washer shape increases an effectiveness of an air seal provided in the motor which increases an efficiency of motors using the washers. The conical washers may also be used in a three-way transfer valve that switches operation of the motor from among a primary power source, a braking energy recuperation pump, and a recouped air acceleration function.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side perspective view of an air motor according to one embodiment of the invention.

FIG. 2 is a cross-sectional side view of an air motor according to one embodiment of the invention.

FIG. 3 illustrates a cutaway view of an exhaust valve of an air motor in three operational states according to one embodiment of the invention.

FIG. 4 is a schematic block diagram of an air motor according to one embodiment of the invention.

FIG. 5 illustrates a contactor mechanism of an air motor in four operational states according to one embodiment of the invention.

FIG. 6 illustrates a conical piston and a conical washer of an air motor according to one embodiment of the invention.

FIG. 7 is a schematic block diagram of an air motor according to one embodiment of the invention.

### DETAILED DESCRIPTION OF THE INVENTION

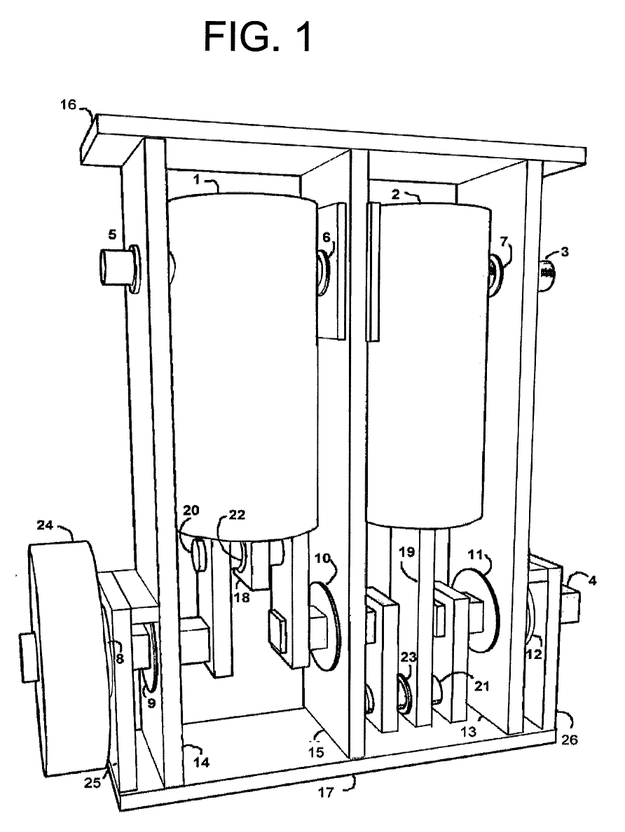

According to one embodiment, the invention includes a device that includes an air powered, two cylinder air motor. The device includes two cylinders 1, 2 supported by a countershaft 3 and a crankshaft 4 as illustrated in FIG. 1. Preferably, the cylinders 1, 2 are lined with a friction-reducing material such as, for example, TEFLON®, although other materials may be used.

The countershaft 3 and crankshaft 4 are supported by countershaft bearings 5, 6, 7 and crankshaft bearings 8, 9, 10, 11, 12, respectively. Both the countershaft 3 and crankshaft 4 are also supported by side support 13, 14 and center support 15. The side supports 13, 14 and center support 15 may be held in place by top plate 16 and bottom plate 17.

Connecting rods 18, 19 provide a linkage between the crankshaft 4 and the cylinders 1, 2. The connecting rods 18, 19 are secured to the crankshaft 4 at one end by pins 20, 21. The pins 20, 21 pass through connecting rod bearings 22, 23 that are provided in each of the connecting rods 18, 19. During operation of the motor, the crankshaft 4 rotates causing the connecting rods 18, 19 to move in an elliptical manner about the crankshaft 4. The cylinders 1, 2 pivot around the countershaft 3 as the connecting rods 18, 19 move downward and outward as the crankshaft 4 rotates. Energy needed to rotate the crankshaft 4 may be stored in, for example, a flywheel 24 mounted on the crankshaft 4. Additional supports 25, 26 may also be provided to support the crankshaft 4.

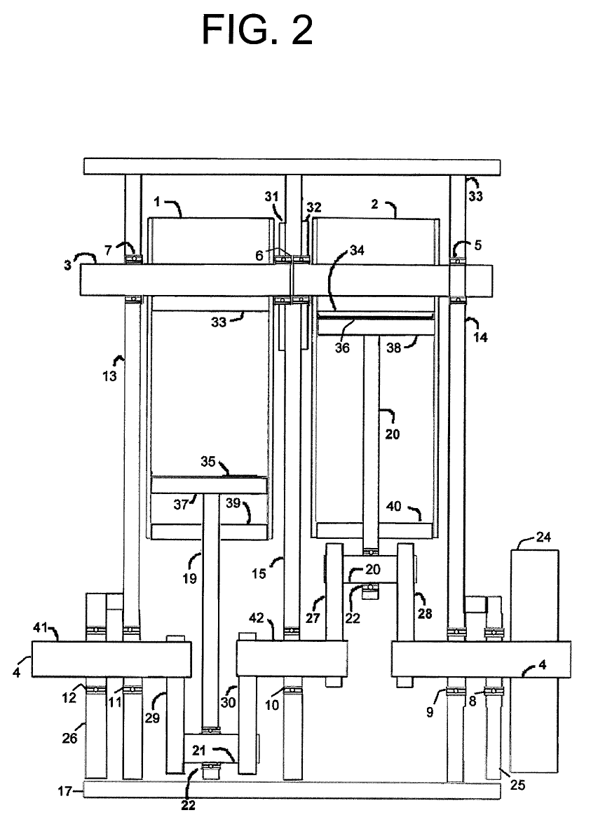

As shown in FIG. 2, the crankshaft 4 includes a plurality of crankshaft links 27, 28, 29, 30 that connect the crankshaft 4 to the connecting rods 18, 19. Cylinders 1, 2 are supported by countershaft 3 which is supported by countershaft bearings 5, 6, 7 which are mounted in side supports 13, 14 and center support 15. According to one embodiment of the invention, additional center supports 31, 32 may be secured to the center support 15. The countershaft bearings 6 may also be provided in the additional center supports 31, 32. Therefore, the crankshaft 3 may pass through the side supports 13, 14, cylinders 1, 2, center support 15, additional center supports 31, 32, and countershaft bearings 5, 6, 7.

Cylinders 1, 2 are sealed at the top by cylinder heads 33, 34 that preferably are press fitted against the countershaft 3 and attached to cylinders 1, 2. Conical pistons 35, 36 and piston backings 37, 38 are attached to one end of the connecting rods 18, 19. The pistons 35, 36 and piston backings 37, 38 move the connecting rods 18, 19 up and down inside the cylinders 1, 2.

The connecting rods 18, 19 are supported by connecting rod guides 39, 40 that are attached to the bottom of the cylinder heads 33, 34. According to one embodiment of the invention, the connecting rod guides 39, 40 are provided with a friction-reducing material such as, for example, TEFLON®, although other materials may be used. The connecting rod guides 39, 40 may be, for example, coated with TEFLON® or other friction-reducing material. Connecting rods 18, 19 transfer their motion to the crankshaft segments 41, 42, 43 by pins 20, 21 which are supported by bearings 22, 23 and crankshaft links 27, 28, 29, 30.

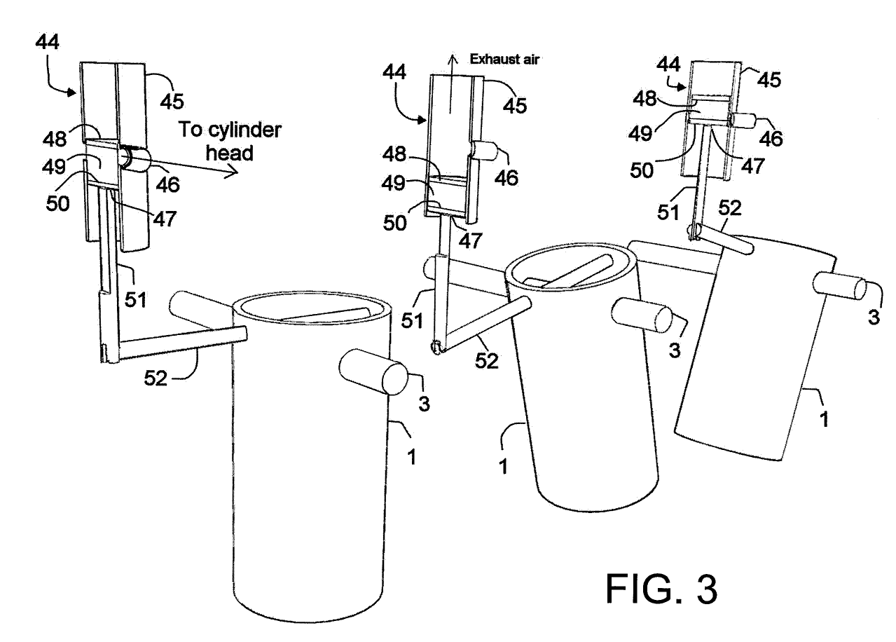

FIG. 3 illustrates an exhaust valve 44 of an air motor in three operational states according to one embodiment of the invention. The exhaust valve 44 includes a valve body 45 with a side pipe 46 for connecting the exhaust valve 44 to a cylinder head. A plunger 47 is provided within the valve body 45 that slides therein. The plunger 47 includes an upper conical washer 48, a spacer 49, a lower conical washer 50, linkage rods 51, 52 that connect the exhaust valve 44 with a motion of cylinder 1 as it moves back and fourth about a countershaft 3.

Three operational states of the exhaust valve 44 are shown in FIG. 3. Operational state (1) is neutral. This is when a piston is at top dead center and the exhaust valve 44 is closed. In operational state (2), the piston is traveling upwardly causing the cylinder to sway downwardly thus pulling the plunger downwardly and allowing air from the cylinder to pass through to the outside. In operational state (3), the cylinder is moving in an opposite direction as described in state (2) during a power stroke of a cylinder and the exhaust valve 44 remains closed.

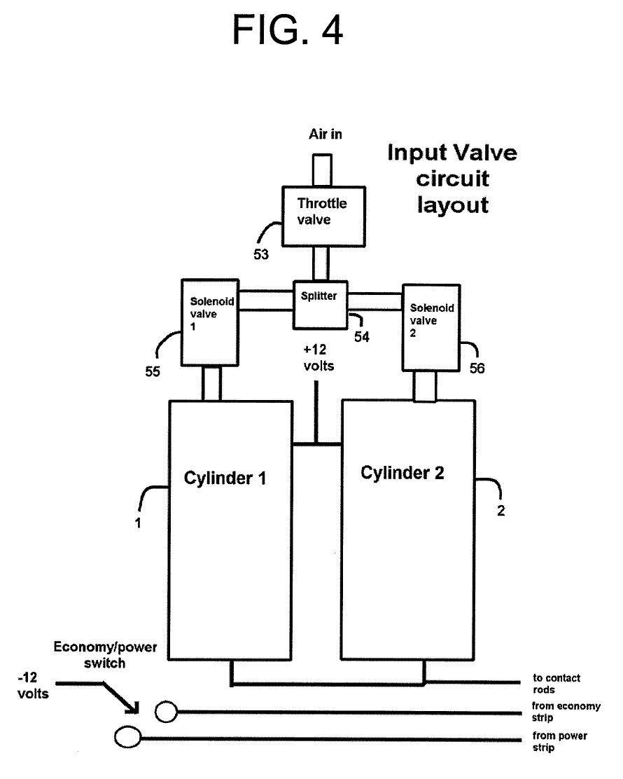

FIG. 4 shows the electrical and pneumatic connections of an air motor according to one embodiment of the invention. Air enters a throttle valve 53 and is then directed to a splitter 54. The splitter 54 divides the air from the throttle valve 53 and directs the air to one of two solenoids 55, 56, one for each cylinder 1, 2. Air leaves the solenoid valves 55, 56 and flows into the cylinders 1, 2. The solenoids 55, 56 preferably run on 12 volts to be compatible with automotive accessories.

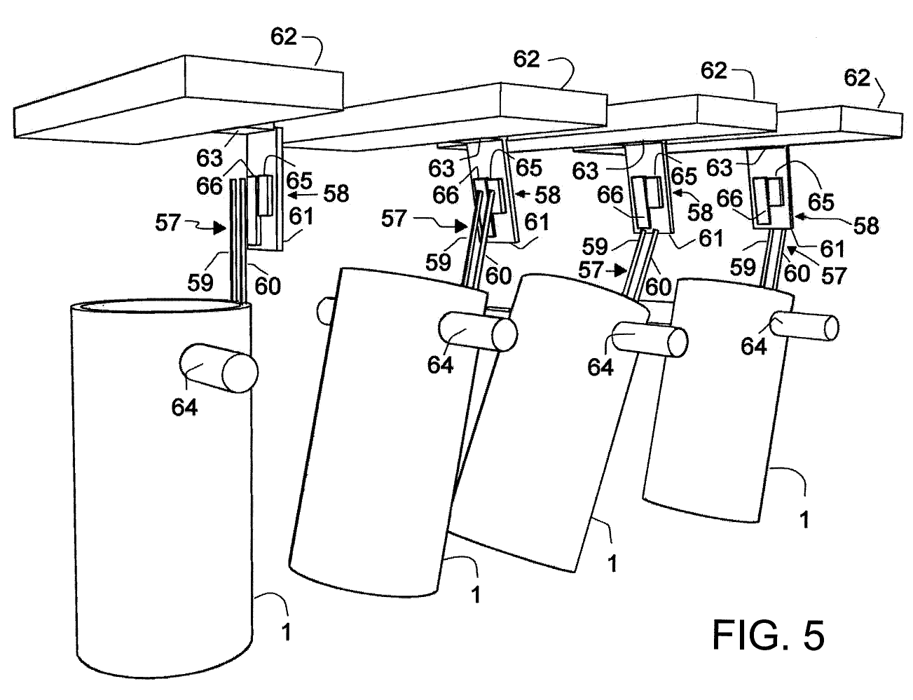

FIG. 5 illustrates a contactor assembly 57 of an air motor in four operational states according to one embodiment of the invention. Electrical connections are made from solenoids (not shown) to a commutator 58 formed by contactor posts 59, 60 mounted to the top of the cylinders 1, 2 and contact flaps 61 mounted to the top of a motor 62 using a mounting plate 63. The contactor assembly 57 moves back and forth around a countershaft (64). Proper activation of input valve solenoids is achieved using the contactor assemblies provided on the top of each cylinder.

The contactor posts 59, 60 make contact with two conductive strips 65, 66 mounted on the contact flap 61 that is fastened to the mounting plate 63 that is attached to the top of the motor 62. One of the conductive strips 65 is shorter than the other conductive strip 66. When the shorter conductive strip 65 is selected, it makes a shorter contact with the contactor post 58 than the longer conductive strip 66 which makes a longer contact with the contactor post 60. The contactor posts 59, 60 control the duration of an input valve opening.

According to one embodiment of the invention, the shorter conductive strip 65 makes a short contact with the contactor post 59 allowing a small charge of air to enter the cylinder 1 that is allowed to expand while pushing a piston (not shown) down the cylinder 1. This extracts an increased amount of energy from air that has been compressed. The longer conductive strip 66 makes a longer contact with contactor post 60 allowing more air at full pressure into the cylinder 1 resulting in more power.

The four operational states of the contactor assembly 57 are illustrated in FIG. 5. During operational state (1), the piston is at top dead center and no contact is made. This is the neutral state. In operational state (2), as the flywheel causes the crankshaft to rotate, the top of the cylinder moves and urges the contactor posts 59, 60 toward the contactor flap 61 having the conductive strips 65, 66 thus making contact and opening the solenoid valve for that cylinder. In operational state (3), as the top of the cylinder continues to turn, the shorter conductive strip 65 loses contact with contactor post 59, however, contact continues between contactor post 60 and the longer conductive strip 66. In operational state (4), the piston has moved past bottom dead center. The contactor posts 59, 60 have moved past the contact flap 61 and is moving back to its vertical position. As the contactor posts 59, 60 have passed under the contact flap 61, they no longer make contact with the conductive strips 65, 66 and thus the input solenoid for this cylinder remains closed while another cylinder is in a power stroke. The cylinders are 180 degrees out of phase, therefore, this process alternates between the two cylinders providing a smooth power stroke with two power impulses per revolution of the crankshaft.

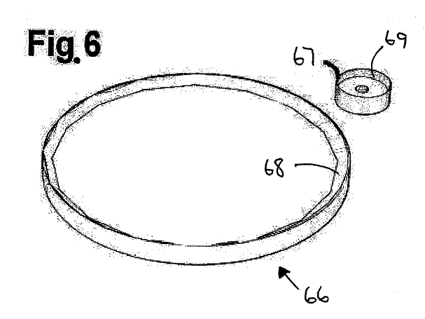

FIG. 6 illustrates a conical piston 67 and a conical washer 68 that may be used with an air motor according to one embodiment of the invention. The conical piston 67 has a flared skirt 69 that points toward a cylinder head (not shown). Some of the air pressure created by the air motor is diverted toward the cylinder (not shown) by virtue of the conical piston geometry. This assists in sealing space between the cylinder and the piston without using piston rings and increasing an effectiveness of an air seal while the air motor is operating.

In an exhaust valve, skirts 70 of the conical washers 68 point toward each other and use pressure in the cylinder to force the skirts 70 against an exhaust valve body. This provides a seal between the plunger and the exhaust valve body that reduces an amount of air passing therebetween. Preferably, the seal is air tight.

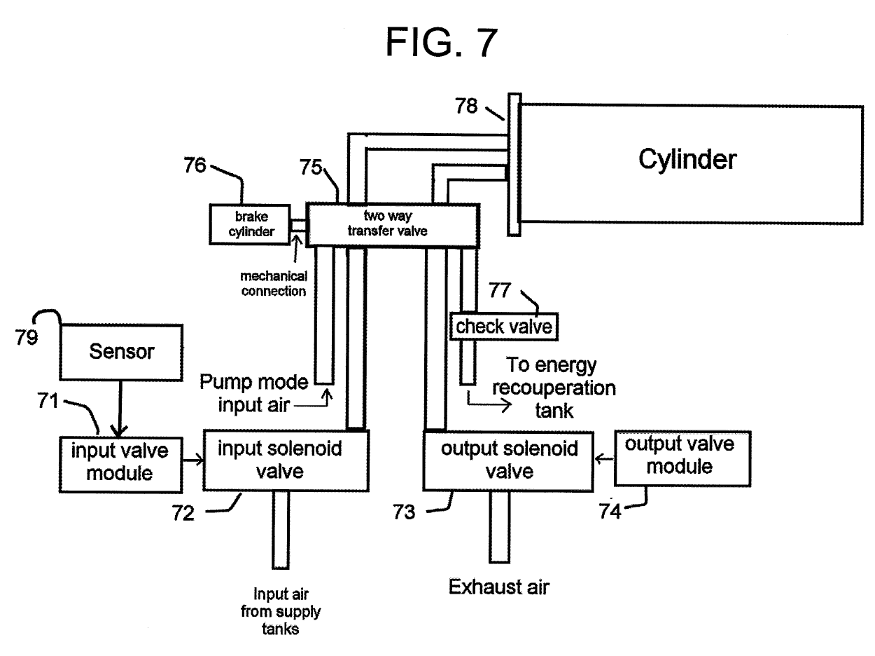

FIG. 7 is a schematic block diagram of an air motor according to one embodiment of the invention. The air motor includes input valve module 71, input solenoid valve 72, output solenoid valve 73, and an output valve module 74. The input valve modules 71, 74 are in communication with corresponding solenoid valves 72, 73. The solenoid valves are in communication with a two way transfer valve 75. The two-way transfer valve 75 is in communication with a brake cylinder 76, check valve 77, and cylinder 78.

The two way transfer valve 75 which switches the air motor between an engine mode and a pump mode. When operated as a pump, the solenoid valves 72, 73 do not provide input to the air motor because, as a pump, only check valve 77 is needed between the air motor and an energy recuperation tank. This also reduces a likelihood that high pressure in the energy recuperation tank will reach the solenoid valves 72, 73.

In pump mode, the input and output valve modules 71, 74 preferably are disabled. During motor operation, a crankshaft sensor 79 senses when a crankshaft has just moved past top dead center. This may be performed by sensing a location of a cam on a camshaft or crankshaft. When this occurs, the sensor 79 transmits a pulse to the input valve module 71 providing an indication that the crankshaft has just moved past top dead center. The input valve module 71 transmits a signal to the input solenoid valve 72 causing the input solenoid valve 72 to open.

The length of the pulse may vary according to needs of a driver operating a vehicle using the air motor. According to one embodiment, the input solenoid valve 72 is closed early (less than 15 degrees after top dead center). To prevent pulse overrun, the sensor 80 may also include a cut-off sensor that signals the input valve module 71 to close if the pulse causes the input solenoid valve 72 to remain open for more than 160 degrees past dead center. The output valve module 74 preferably keeps the output solenoid valve 73 open from 180 degrees to 360 degrees past top dead center.

The many features and advantages of the invention are apparent from the detailed specification, and thus, it is intended by the appended claims to cover all such features and advantages of the invention which fall within the true spirit and scope of the invention. For example, although the invention has been described in terms of a two-cylinder motor, any suitable number of cylinders may be used. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The invention claimed is:

1. An air powered device comprising:
at least one cylinder;
a piston housed within the at least one cylinder;
a crankshaft operatively connected to the piston;
a countershaft operatively connected to the at least one cylinder; and
an air source operatively coupled to the cylinder.

2. The device of claim 1, wherein movement of the at least one cylinder about the countershaft controls at least one of input and output valves of the device.

3. The device of claim 1, wherein the device is operated as at least one of an air motor and a steam engine.

4. The device of claim 1, further comprising an electronic switching system.

5. The device of claim 1, further comprising any one of a conical piston seal and a conical washer.

6. The device of claim 1, wherein the at least one cylinder comprises friction-reducing material.

7. The device of claim 6, wherein the friction-reducing material comprises TEFLON®.

8. The device of claim 1, further comprising a flywheel operatively connected the crankshaft.

9. The device of claim 1, further comprising a sensor configured to sense a position of a crankshaft.

10. The device of claim 9, wherein the sensor senses a position of a cam.

11. The device of claim 1, further comprising at least any one of an input valve module and an output valve module.

12. The device of claim 1, further comprising a two way transfer valve.

13. A method of operating an air motor comprising:
sensing a position of a crankshaft;
opening a valve of an air motor when a predetermined position of the crankshaft is sensed;
transmitting a signal to a valve causing the valve to remain open for a predetermined period of time; and
forcing air into a cylinder of an air motor.

14. The method of claim 13, further comprising varying the signal to cause a change in the predetermined period of time.

15. The method of claim 13, wherein the sensing senses a position of a cam.

16. The method of claim 15, wherein the sensing senses a location of the crankshaft at a position after a top dead center location.

17. The method of claim 13, further comprising transmitting a close signal to the valve causing the valve to close.

18. The method of claim 17, wherein the close signal is transmitted if the valve remains open after the crankshaft has moved more than one-hundred-sixty degrees past dead center.

19. The method of claim 13, further comprising capturing air from the air motor during a braking operation.

20. The method of claim 19, further comprising feeding air captured from the air motor to the cylinder.
